(19) United States
(12) Patent Application Publication
(10) Pub. No.: US 2024/0035690 A1
(43) Pub. Date: Feb. 1, 2024

(54) FILTER ELEMENT COMPRISING GRAPHENE FOR AIR CONDITIONING UNITS

(71) Applicant: DIRECTA PLUS S.P.A., Lomazzo (CO) (IT)

(72) Inventors: Laura Giorgia Rizzi, Saronno (IT); Giulio Giuseppe Cesareo, Como (IT)

(21) Appl. No.: 18/268,751

(22) PCT Filed: Dec. 27, 2021
(86) PCT No.: PCT/EP2021/087692

§ 371 Date: Jun. 21, 2023

(30) Foreign Application Priority Data
Dec. 29, 2020 (IT) 102020000032693

(51) Int. Cl. F24F 8/108; B01D 39/14; D06M 11/74

(52) U.S. Cl. CPC F24F 8/108; B01D 39/14; D06M 11/74; B01D 2239/0258; B01D 2239/0407; B01D 2239/0442; B01D 2239/0464

(57) ABSTRACT

Filter element for air conditioning unit comprising a textile substrate selected from woven fabric and nonwoven fabric, and a composition comprising graphene, in which said graphene is in the form of nano-platelets and is present in an amount from 2 to 20 g of graphene per square meter of textile substrate and is dispersed in a binding agent and applied uniformly on all said textile substrate by means of impregnation.

The present invention refers to a filter element comprising graphene for air conditioning units.

### BACKGROUND OF THE INVENTION

Air conditioning units are used in various applications in both civil and industrial sectors and comprise filters for trapping dusts, fumes and atmospheric aerosol. Air conditioning units provided with these filters are also widely used in the motor vehicle sector.

In recent years the need has also emerged to filter the air circulating in the passenger compartment of vehicles, both with respect to atmospheric particulate matter and with respect to pathogenic microorganisms such as bacteria, fungi and viruses.

CN 107983015 A describes a filter element with antibacterial properties for an air conditioner for motor cars. The material of the filter element comprises various components, including a fabric made of polyurethane fibers coated with a suspension of graphene oxide in heptane. Another component of the filter element is a filtering cotton produced by activated charcoal, expanded ceramic particles and animal hair treated with graphene.

WO 2019/202028 A1 describes a textile article on which a pattern comprising graphene is applied, and the related manufacturing process by means of printing. The pattern defines a surface with empty portions on which graphene is not present and full portions on which graphene is present. The graphene is applied using the screen-printing method. In view of the fact that the empty surface portions of the article, i.e., the parts on which graphene is not present, vary from 30 to 90% of the total surface, the textile article cannot form an effective antibacterial barrier.

The recent Covid-19 pandemic has accentuated the need for air filters that offer a good level of protection both with respect to atmospheric particulate matter and with respect to pathogenic agents.

### SUMMARY OF THE INVENTION

Therefore, an object of the present invention is to provide a filter element that can be advantageously used in the production of filters for air conditioning units, both for civil and industrial use.

Another object of the invention is to provide a filter element that can be advantageously used in the production of filters for air conditioning units adapted to eliminate or reduce the passage and transmission of pathogenic agents such as bacteria, fungi and viruses.

A further object of the invention is to provide a filter element that can be advantageously used in the production of filters for air conditioning units so as to minimize the pressure drop of the air flow that passes through the filter.

A particular object of the present invention is to provide a filter element that can be advantageously used in the production of filters for air conditioning units for motor vehicles.

Therefore, an aspect of the present invention relates to a filter element for air conditioning units comprising a textile substrate selected from woven fabric and nonwoven fabric, and a composition comprising graphene, characterized in that said graphene consists of graphene nano-platelets in which at least 90% have a lateral dimension (x, y) from 500 to 50000 nm and a thickness (z) from 0.34 to 50 nm, said graphene being present in an amount from 2 to 20 g of graphene per square meter of textile substrate and being dispersed and applied uniformly on all said textile substrate and inside it.

According to an aspect of the present invention, said graphene nano-platelets have a C/O ratio is ≥100:1.

According to an aspect of the present invention, said composition comprising graphene consisting of graphene nano-platelets in which at least 90% have a lateral dimension (x, y) from 500 to 50000 nm and a thickness (z) from 0.34 to 50 nm, is applied to said textile substrate by means of impregnation.

Another aspect of the present invention relates to an air filter for air conditioning units of motor vehicles comprising a filter element as defined above.

### BRIEF DESCRIPTION OF THE DRAWINGS

FIGS. 1 and 2 show filter elements according to the invention; and

FIG. 3 shows a filter element according to the invention for producing an air filter for motor vehicles.

### DESCRIPTION OF THE INVENTION

The filter element according to the present invention comprises a textile substrate selected from woven fabrics and nonwoven fabrics. This substrate is suitable for producing articles with filtering properties.

According to the present invention, the term “textile substrate” is meant as a substantially flat substrate selected in the group consisting of woven fabrics and nonwoven fabrics (or nonwovens), on which a composition comprising graphene has not yet been applied.

The term “nonwoven fabric” (or nonwoven) indicates a textile article similar to a woven fabric but obtained with procedures other than weaving. In the nonwoven, the fibers have a random trend, without the formation of a structure ordered in warp and weft yarns, and are typically arranged in layers or in a crisscross orientation and are bonded together mechanically or with glues or heat processes.

The term “nonwoven fabric” is also meant as felts.

Woven fabric can be made of natural, artificial or synthetic fiber, while nonwoven fabric is typically made of artificial or synthetic fibers.

In the present description, the term “filter element” is meant as an article comprising a substantially flat textile substrate as defined above, on which a composition comprising graphene. The term “filter element” also comprises the combination or one or more of said substrates and if necessary other substances present between said substrates.

The filter element according to the present invention is destined for the production of filters for air conditioning units, both for civil and industrial use, including air filters for motor vehicles.

As a function of the specific application, the filter element can take various forms. For example, it can be folded or pleated in order to increase the surface area per unit of volume, or it can be wound around itself or around other parts of the air conditioning unit.

The filter element according to the invention comprises graphene in the form of nano-platelets in which at least 90% have a lateral dimension (x, y) from 500 to 50000 nm and a thickness (z) from 0.34 to 50 nm.

According to an aspect of the invention, the term “graphene” does not comprise carbon nanotubes but only the graphene in the form of nano-platelets with the dimension defined above.

According to an aspect of the invention, the graphene contained in the filter element has a C/O ratio ≥100:1.

According to an aspect of the invention, at least 90% of the graphene nano-platelets have a thickness (z) from 0.34 to 10 nm.

According to an aspect of the invention, the graphene contained in the filter element comprises graphene nano-platelets in which at least 90% have a lateral dimension (x, y) from 500 to 50000 nm and a thickness (z) from 0.34 to 10 nm, and in which the C/O ratio is ≥100:1.

According to an aspect of the invention, the graphene contained in the textile article is present in an amount from 2 to 20 g of graphene per square meter of textile substrate.

According to a preferred aspect of the invention, the composition comprising graphene does not contain antibacterial or antiviral agents comprising metal elements or metal compounds, i.e., the composition comprising graphene is free from antibacterial or antiviral agents comprising metal elements or metal compounds.

Preferably, the filter element comprises graphene in an amount from 4 to 15 g of graphene per square meter of textile substrate.

According to the present invention, the filtering properties of the substrate are greatly increased by application of the graphene with the impregnation method.

According to an aspect of the present invention, the increase in the pressure drop through the filter element is not high, i.e., the filter element produces efficient filtration and allows the passage of an optimal air flow.

The pressure drop through the filter element is measured using the method described in the standard UNI EN 14683:2019 relating to the respiratory resistance of surgical masks.

Although the filter element of the present invention has not been expressly conceived for the production of surgical masks, the method described in the standard UNI EN 14683:2019 can in any case be used to express and quantify the pressure drop of an air flow that passes through a textile filter element.

The filter element according to the present invention shows an increase in pressure drop, with respect to the pressure drop shown by the textile substrate not treated with graphene, lower than 60%, preferably lower than 50%, measured with the standard UNI EN 14683:2019.

The filter element according to the present invention shows an antibacterial and antiviral activity with respect to the textile substrate not treated with graphene.

The standard UNI ISO 20743 measures the antibacterial capacity of a textile product. The test takes place using a culture in a Petri dish, i.e., the sample of treated textile substrate and the untreated reference sample are placed in the culture medium and incubated at 37° C., with bacterial count before and after the incubation period. The test provides a number correlated to the antibacterial activity of the fabric. Typically, Staphylococcus aureus is used as gram-positive bacterial strain and Escherichia coli or Klebsiella as gram-negative. The result is expressed with the following values:

from 0 to 1: no antibacterial property
from 1 to 2: slight antibacterial property
from 2 to 3: significant antibacterial property
over 3: strong antibacterial property.

The antibacterial activity according to the standard UNI ISO 20743:2013 of the filter element according to the present invention is higher than 1.

According to an aspect of the invention, the antibacterial activity is higher than 1.5.

The standard UNI ISO 18184:2019 determines the antiviral activity of the textile products.

The methodology, although not excluding the use of other viruses, normally use Feline Calicivirus (VR-782) as enveloped virus and an influenza virus (H3N2 or H1N1) as non-enveloped virus. Recently, the virus responsible for the disease SARS-CoV-2, or COVID-19, has also been used.

The standard provides for observation of the live cells that the virus infects in order to replicate.

The effective performance of the textile sample treated is determined by measurement of the viral load using a plaque assay or the TCID₅₀ (median tissue culture infectious dose) method. The result expresses the percentage reduction of viral activity with respect to the reference.

The antiviral activity of the filter element of the invention according to the standard ISO 18184:2019 is higher than 50%.

According to an aspect of the invention, the antiviral activity is higher than 60%.

The graphene contained in the filter element forms a thermal circuit capable of absorbing and distributing heat so as to allow heating of the filter element by means of exposure to electromagnetic radiation, for example in the infrared, ultraviolet or microwave field. It is thus possible to sanitize the filter element simply by heating, in a rapid and economical way.

Moreover, the graphene also forms an electric circuit that allows dissipation of the static electricity accumulated on the textile article, but also heating of the article through Joule effect by applying a voltage at the ends of the circuit, if appropriately provided for.

It must be borne in mind that the textile substrates defined above consist of insulating materials, i.e., they have a surface resistivity higher than 2.5·10¹²Ω measured according to the standard JIS K 7194.

With regard to the material of which the textile substrate, and hence the filter element, is produced it has been said that the woven fabric can be made of natural, artificial or synthetic fiber, while the nonwoven, including felts, are typically made with artificial fibers or synthetic resins.

Useful natural fibers include, for example, wool, silk and cotton. Useful artificial fibers include modified or regenerated cellulose fibers, such as glass fibers, viscose and cellulose acetate. Useful synthetic fibers comprise polyamides, including aromatic polyamides (aramids), polyester, polyurethane, polyaciylonitrile, polycarbonate, polypropylene, polyvinylchloride and blends thereof. Moreover, fabrics obtained from blends of natural, artificial and synthetic fibers can advantageously be used.

With regard to the type of textile substrate, the following substrates can be used.

### Nonwoven Fabric (Nonwoven):

Nonwovens used fall within the following categories:

### Spunlace

This is a nonwoven fabric deriving from a process called hydroentangling. The process uses high pressure water jets that perforate the fabric and intertwine the fibers giving the fabric greater substance. The consolidation of plies of fibers by means of high pressure water jets causes these to perforate the fabric and intertwine the fibers without damaging them, as can occur with needle punching. Intertwining of the fibers in various directions gives the nonwoven an isotropic property and the same strength in various directions.

### Spunbond

This is a nonwoven fabric obtained by processing nonwoven synthetic fibers. The characteristic of this nonwoven is that of thermal point bonding between the fibers. This characteristic mechanically bonds the fibers to one another and imparts the “point bonding” characteristic, which is usually square or oval and makes the fabric both soft and strong.

### Felts

Another type of textile substrate that can be used is felt, consisting of synthetic fibers tangled and consolidated so as to form a compact structure using mechanical operations, as is known in the art.

### Woven Fabrics

These are textile substrates obtained by weaving yarns on a loom, as is known in the art.

### Other Textile Substrates

Multi-layer structures composed of fabrics and membranes, bonded nonwoven and woven fabric structures.

### Graphene

As regards graphene, it comprises, or consists of, graphene nano-platelets in which at least the 90% have a lateral dimension (x, y) from 50 to 50000 nm and a thickness (z) from 0.34 to 50 nm. Preferably, the C/O ratio of the graphene nano-platelets is ≥100:1. Preferably, at least 90% of the graphene nano-platelets have a thickness (z) from 0.34 to 10 nm.

The scientific and patent literature describes various methods for the preparation of graphene, such as chemical vapor deposition, epitaxial growth, chemical exfoliation and chemical reduction of the oxidized form graphene oxide (GO).

The Applicant Directa Plus S.p.A. is the holder of patents and patent applications relating to production methods of structures comprising layers of graphene, such as EP 2 038 209 B1, WO 2014/135455 A1 and WO 2015/193267 A1. The last two patent applications cited describe production methods of pristine graphene dispersions, from which it is possible to obtain graphene nano-platelets with the dimension required for implementation of the present invention, and with a C/O ratio ≥100:1. This ratio is important as it defines the maximum amount of oxygen bonded to the carbon forming the graphene. In fact, the best properties of graphene, which derive from its high crystallographic quality, are obtained when the amount of oxygen is minimum.

A pristine graphene, i.e., with a C/O ratio ≥100, and having the characteristics of size defined previously, is produced and marketed by Directa Plus S.p.A. with the trade name G+®.

The C/O ratio in the graphene used in the textile article according to the invention is determined by means of elemental analysis performed by elemental analyzer (CHNS O), which provides the percentage by weight of the various elements. The C/O ratio is obtained by normalizing the values obtained with respect to the atomic weight of the C and O species and finding their ratio.

It was found that graphene in oxidized form, just as that in the form obtained through reduction of graphene oxide (GO), has different characteristics and properties to pristine graphene. For example, the electrical and thermal conductivity characteristics and the mechanical strength of pristine graphene are superior to those of GO and to the reduction product obtained therefrom, also due to the presence of numerous lattice defects and imperfections of the crystalline structure caused by the reduction reaction.

The lattice defects of the nano-platelets can be evaluated by Raman spectroscopy analyzing intensity and shape of the Peak D positioned at 1350 cm⁻¹.

According to embodiments described in the patent documents mentioned above by the Applicant Directa Plus S.p.A., the continuous process for producing pristine graphene is carried out continuously feeding graphite flakes to the step of expansion at high temperature, continuously discharging the expanded graphite thus obtained in an aqueous medium and continuously subjecting the expanded graphite dispersed in the aqueous medium to exfoliation and size reduction treatment carried out with ultrasonication and/or high pressure homogenization methods.

As described in these patent documents, the final dispersion of graphene nano-platelets obtained can be concentrated or dried, according to the final form desired for the graphene.

The purpose of drying the dispersion is to obtain a dry powder that is easily redispersible in various matrices, both solvents and polymers, where liquid is not desirable or manageable at process level, or where water cannot be used due to chemical incompatibility.

A significant advantage of the production processes described in the patent documents WO 2014/135455 A1 and WO 2015/193267 A1 consists in the possibility of operating without using surfactants. In fact, the graphene nano-platelets thus obtained are pristine, both due to the high C/O ratio and to the absence of extraneous substances, such as surfactants, which could contaminate them. In fact, it was found that in the absence of surfactants it is possible to obtain graphene having an electrical conductivity substantially higher than that of graphene obtained with processes using surfactants. This improves the performance of graphene in a plurality of applications.

Pristine graphene nano-platelets, at least 90% of which have a lateral dimension (x, y) from 50 to 50000 nm and a thickness (z) from 0.34 to 50 nm, with a C/O ratio ≥100:1, have a high electrical conductivity. It was also seen that when a dispersion of graphene nano-platelets is formed in the presence of a surfactant, this deposits on the surface thereof and tends to promote tangling thereof.

In the present description the dimensions of the graphene nano-platelets are defined with reference to a system of Cartesian axes x, y, z, it being understood that the particles are substantially flat platelets but can also have an irregular shape. In any case, the lateral dimension and the thickness provided with reference to the directions x, y and z are meant as the maximum dimensions in each of the aforesaid directions.

The lateral dimensions (x, y) of the graphene nano-platelets are determined, within the scope of the production process described above, by direct measurement on the scanning electron microscope (SEM), after having diluted the final dispersion in a ratio of 1:1000 in deionized water and having added it dropwise on a silicon oxide substrate placed on a plate heated to 100° C.

Alternatively, if nano-platelets in dry state are available, SEM analysis is carried out directly on the powder deposited on a double-sided adhesive carbon tape. In both cases the measurement is carried out on at least 100 nano-platelets.

The thickness (z) of the graphene nano-platelets is determined with the atomic force microscope (AFM), which is essentially a profilometer with subnanometer resolution, widely used for the characterization (mainly morphological) of surfaces and of nanomaterials. This type of analysis is commonly used to evaluate the thickness of graphene flakes, produced using any method, and thus find the number of layers of which the flake is composed (single layer=0.34 nm).

The thickness (z) can be measured using a dispersion of nano-platelets diluted in a ratio of 1:1000 in isopropanol, from which 20 ml is then collected and sonicated in an ultrasonic bath (Elmasonic S40) for 5 minutes. The nano-platelets are then deposited as described for SEM analysis and are scanned directly with an AFM tip, where the measurement provides a topographical image of the graphene flakes and their profile with respect to the substrate, enabling precise measurement of the thickness. The measurement is carried out on at least 50 nano-platelets.

Alternatively, if nano-platelets in dry state are available, the powder is dispersed in isopropanol at a concentration of 2 mg/L. An amount of 20 ml is collected and sonicated in an ultrasonic bath (Elmasonic S40) for 30 minutes. The nano-platelets are then deposited as described for SEM analysis and are scanned by AFM.

In the concentrated final dispersion or in the dry form obtained after drying, at least 90% of the graphene nano-platelets preferably have a lateral dimension (x, y) from 50 to 50000 nm and a thickness (Z) from 0.34 to 50 nm, and a C/O ratio ≥100:1. Preferably, at least 90% of the graphene nano-platelets have a lateral dimension (x, y) from 500 to 10000 nm and a thickness (z) from 0.34 to 10 nm, more preferably a lateral dimension (x, y) from 500 to 8000 nm, and even more preferably from 500 to 5000 nm, and preferably a thickness (z) from 0.34 to 8 nm, more preferably from 0.34 to 5 nm.

The graphene nano-platelets, hereinafter also called GNPs, having the aforesaid characteristics of dimension and purity, thus having a very low oxygen content, as defined by the aforesaid C/O ratio and not functionalized with other molecules, proved to be particularly suitable for application to a textile substrate to obtain a textile article having excellent filtering and antibacterial properties, and also antiviral properties, without causing excessive pressure drops in the air passing through them. Moreover, the high electrical conductivity of the graphene is useful for dissipating any electrostatic energy that has accumulated on the filter element.

### Method of Applying the Graphene to the Textile Substrate by Impregnation

The method provides for impregnation of the textile substrate in an aqueous bath containing graphene in the form of dispersed GNPs. The method allows the GNPs to be deposited not only on the surface of the textile substrate but also inside it between the interstices of the fibers. The GNPs are dispersed by stirring in the impregnation bath to obtain a homogeneous dispersion. According to an embodiment, the impregnation bath is an aqueous bath in which the GNPs are dispersed in the presence of a binding agent and an anti-migrating agent.

In an embodiment the impregnation bath comprises:
A) from 5 to 25 g/l of graphene having the characteristics of size defined above
B) from 50 to 200 g/l of a binding agent
C) from 5 to 20 g/l of an anti-migrating agent.

In a preferred embodiment the composition comprises:
A) from 10 to 20 g/l of graphene
B) from 70 to 150 g/l of binding agent
C) from 7 to 15 g/l of anti-migrating agent.

Preferably, the binding agent is an emulsion of acrylic polymers to which softeners and cross-linking agents, used in the dyeing industry for pigment dyeing of cellulose, synthetic and blended fabrics, are added. It has now been found that this binding agent ensures good adhesion of the GNPs to the textile substrate fibers.

Preferably, the anti-migrating agent is an anti-migrating and wetting agent used in the dyeing industry for pigment dyeing. It has now been found that this anti-migrating agent guarantees a good level of penetration of the impregnation bath into the substrate and a uniform distribution of the GNPs inside the substrate.

The preparation process of the textile article according to the invention comprises preparation of the impregnation bath with the composition described above and application thereof to the textile substrate by impregnation.

Application consists of immersing the textile substrate in an impregnation tank fed continuously with the impregnation bath from a storage tank kept under constant stirring. The textile substrate is made to pass continuously through the tank with a movement that takes place with the use of rollers. After impregnation, the fabric is passed between two rollers to eliminate the excess liquid. Finally, the fabric is fed through an oven at a temperature between 130 and 190° C. for a time from 1 to 5 minutes to fix the binder.

During the impregnation process both the storage tank and the impregnation tank are kept at room temperature. The speed at which the textile substrate is fed and the pressure between the rollers that eliminate the excess liquid after the passage through the impregnation bath are regulated to obtain the desired amount of composition containing graphene, binder and anti-migrating agent according to the thickness of the textile substrate to be treated and the percentage of graphene required for the filter element. The feed speed of the textile substrate in the impregnation bath varies from 5 m/min to 60 m/min.

The composition of the impregnation bath and the characteristics of the impregnation process described above have made it possible to solve the problems encountered at industrial level in producing a dispersion of hydrophobic solid particles in a liquid, such as graphene in an aqueous bath, as the solid particles tend to cluster, form larger particles and sediment. This is especially true for baths in which the concentration of graphene is high, such as in the case of the present invention.

The impregnation process described above can also be implemented on a multi-layer textile substrate, for example composed of two or more layers of woven fabric or of nonwoven.

It is also possible for other substances having filtering or absorbent properties, such as activated charcoal, to have been previously incorporated in the multi-layer textile substrate.

As shown also by the following examples, the invention makes it possible to use textile substrates with normal or low antibacterial efficiency to produce filter elements with high antibacterial efficiency by the application of graphene in the amounts described. The pressure drop through the filter element thus obtained is limited, meaning that the filter element can be used for the manufacture of air conditioning units, including air filters for the motor vehicle sector.

The examples below illustrate some embodiments of the invention and are provided by way of non-limiting example.

### EXAMPLES

### Example 1: Glass Fiber Filter Element

A textile substrate consisting of a nonwoven composed of glass fiber with a weight of 128 g/m² and a thickness of 0.451 μm was used.

The fabric was impregnated with the method described above using a water-based impregnation bath comprising:
13.5 g/L of GNPs of Graphene G+ manufactured and marketed by Directa Plus SpA, in which 90% of the graphene nano-platelets have a lateral dimension from 500 to 50000 nm, a thickness from 0.34 to 50 nm and a C/O ratio ≥100;
100 g/L of binding agent Padding FM N marketed by Achitex Minerva SpA;
10 g/L of anti-migrating agent Sinergil N30 marketed by Achitex Minerva SpA.

After having passed through a pair of co-rotating rollers that eliminate the excess bath, the impregnated nonwoven fabric is heated to 150° C. for 3 minutes.

The amount of graphene incorporated by the substrate was 7.8 g/m², corresponding to 0.06 grams of graphene per 1 gram of nonwoven.

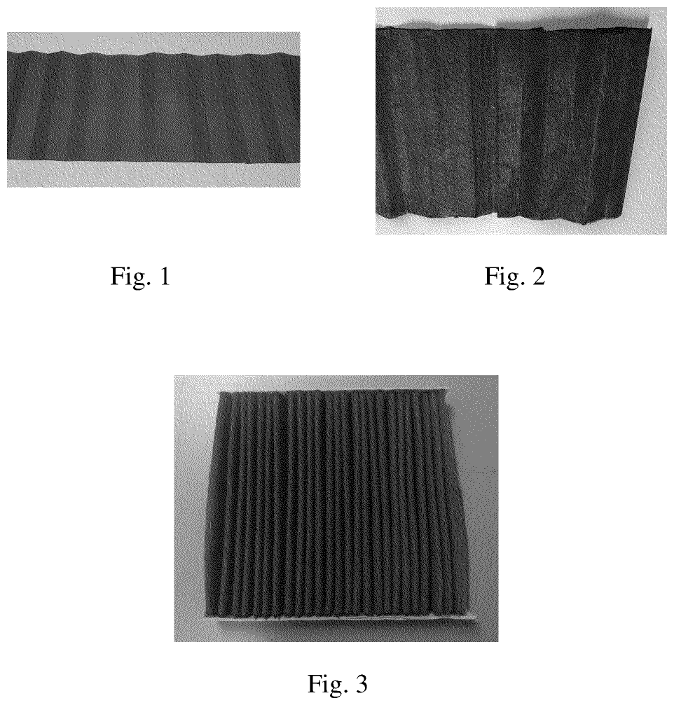

After drying, the filter element was cut to the appropriate size and pleated to obtain a larger filtering surface area and be used as air filter in an air conditioning unit for motor vehicles (FIG. 1).

Characterization:

Surface resistivity: 1.3×10⁶ Ω/sq.

Pressure drop in the air flow through the non-impregnated substrate=2.4 Pa/cm²

Pressure drop in the air flow through the filter element obtained after impregnation: 3.7 Pa/cm²

Increase in the pressure drop: 54%

### Antibacterial Capacity Measured According to UNI ISO 20743

Non-impregnated substrate: 0.9 for Klebsiella pneumoniae and 0.8 for Staphylococcus aureus.

Impregnated substrate >6.3 for Klebsiella pneumoniae and 4.3 for Staphylococcus aureus.

### Antiviral Capacity Measured According to UNI ISO 18184:2019

Non-impregnated substrate: reduction of 17% of the viral load

Impregnated substrate: reduction of 92% of the viral load.

### Example 2: Multi-Layer Filter Element Containing Activated Charcoal

A textile substrate composed of a three-layer fabric in which one layer consists of polypropylene, one of polyethylene terephthalate and another of polyamide, was used. A layer of activated charcoal in the form of granular particles with size ranging from 50 μm to 1 mm was incorporated inside these layers.

The weight of the fabric was 570 g/m² and the thickness of the fabric 1.5 mm.

The fabric was impregnated with the method described above using a water-based impregnation bath comprising:
13.5 g/L of GNPs of Graphene G+ manufactured and marketed by Directa Plus SpA, in which 90% of the graphene nano-platelets have a lateral dimension from 500 to 50000 nm, a thickness from 0.34 to 50 nm and a C/O ratio ≥100.
100 g/L of binding agent Padding FM N marketed by Achitex Minerva SpA
10 g/L of anti-migrating agent Sinergil N30 marketed by Achitex Minerva SpA.

After having passed through a pair of co-rotating rollers that eliminate the excess bath, the impregnated multi-layer fabric is heated to 150° C. for 3 minutes.

The amount of graphene incorporated by the substrate was 6.5 g/m², corresponding to 0.01 grams of graphene per 1 gram of fabric.

After drying, the filter element was cut to the appropriate size and pleated to obtain a larger filtering surface area and be used as air filter in an air conditioning unit for motor vehicles (FIG. 2).

The pleated filter element was then glued with hot melt adhesive to two polyester side elements with a thickness of 3 mm that hold it in position and ensure the necessary mechanical properties for assembly in an air conditioning unit of a motor vehicle, and for its maintenance (FIG. 3).

### Characterization:

Surface resistivity after heating: 4.5×10⁵ Ω/sq.

Pressure drop in the air flow through the non-impregnated substrate=5.7 Pa/cm²

Pressure drop in the air flow through the filter element obtained after impregnation: 8.2 Pa/cm²

Increase in the pressure drop: 44%

Antibacterial capacity values measured according to UNI ISO 20743 Non-impregnated substrate: 0.8 for Klebsiella pneumoniae and 0.9 for Staphylococcus aureus.

Impregnated substrate >5.5 for Klebsiella pneumoniae and 4.1 for Staphylococcus aureus.

### Antiviral Capacity Values Measured According to UNI ISO 18184:2019

Non-impregnated substrate: reduction of 28% of the viral load.

Impregnated substrate: reduction of 89% of the viral load.

1-11. (canceled)

12. A filter element for an air conditioning unit, the filter element comprising:
a textile substrate selected from woven and nonwoven fabric; and
a composition comprising graphene, wherein the graphene comprises nano-platelets in which at least ninety percent (90%) have a lateral dimension from 500 nm to 50000 nm and a thickness from 0.34 nm to 50 nm,
wherein the graphene is present in an amount from 2 g to 20 g of graphene per square meter of textile substrate, and
wherein the graphene is applied on the textile substrate and inside the textile substrate.

13. The filter element of claim 12, wherein the graphene is uniformly applied on all the textile substrate.

14. The filter element of claim 12, wherein the graphene has a carbon-oxygen (C/O) ratio of ≥100:1.

15. The filter element of claim 12, wherein the graphene is present in an amount from 4 g to 15 g of graphene per square meter of textile substrate.

16. The filter element of claim 12, configured wherein an increase in pressure drop for the textile substrate treated with the graphene, with respect to a pressure drop shown by textile substrate not treated with the graphene, is lower than 60% as measured with standard UNI EN 14683: 2019.

17. The filter element of claim 12, comprising an antibacterial activity according to the standard UNI ISO 20743: 2013 higher than 1.

18. The filter element of claim 17, comprising an antibacterial activity according to the standard UNI ISO 20743: 2013 higher than 1.5.

19. The filter element of claim 12, comprising an antiviral activity according to the standard ISO 18184: 2019 higher than 50%.

20. The filter element of claim 19, comprising an antiviral activity according to the standard ISO 18184: 2019 higher than 60%.

21. The filter element of claim 12, wherein the composition comprising graphene is free from antibacterial or antiviral agents comprising metal elements or metal compounds.

22. A method for manufacturing a filter element for an air conditioning unit, the method comprising:
impregnation of a textile substrate in an aqueous bath containing graphene, wherein the textile substrate is selected from woven and nonwoven fabric, the graphene comprising nano-platelets in which at least ninety percent (90%) have a lateral dimension from 500 nm to 50000 nm and a thickness from 0.34 nm to 50 nm, and in which a carbon-oxygen (C/O) ratio is ≥100:1, wherein the impregnation bath is an aqueous bath in which the graphene nano-platelets are dispersed;
wherein the graphene is present in an amount from 2 g to 20 g of graphene per square meter of textile substrate; and
wherein the graphene is applied on the textile substrate and inside the textile substrate.

23. The method of claim 22, wherein the graphene is uniformly applied on all the textile substrate.

24. The method of claim 22, wherein the graphene is present in an amount from 4 g to 15 g of graphene per square meter of textile substrate.

25. The method of claim 22, wherein the filter element comprises an antibacterial activity according to the standard UNI ISO 20743: 2013 higher than 1.5.

26. The method of claim 22, wherein the filter element comprises an antiviral activity according to the standard ISO 18184: 2019 higher than 60%.

27. An air conditioning unit comprising a filter element, wherein the filter element comprises:
a textile substrate comprising woven or nonwoven fabric; and
a composition comprising graphene, wherein the graphene comprises nano-platelets in which at least ninety percent (90%) have a lateral dimension from 500 nm to 50000 nm and a thickness from 0.34 nm to 50 nm,
wherein the graphene is present in an amount from 2 g to 20 g of graphene per square meter of textile substrate, and
wherein the graphene is applied on the textile substrate and inside the textile substrate.

28. The air conditioning unit of claim 27, wherein the graphene has a carbon-oxygen (C/O) ratio of ≥100:1.

29. The air conditioning unit of claim 27, wherein the graphene is present in an amount from 4 g to 15 g of graphene per square meter of textile substrate.

30. The air conditioning unit of claim 27, wherein the filter element comprises an antibacterial activity according to the standard UNI ISO 20743: 2013 higher than 1.5.

31. The air conditioning unit of claim 27, wherein the filter element comprises an antiviral activity according to the standard ISO 18184: 2019 higher than 60%.
